(19) United States
(12) Patent Application Publication
(10) Pub. No.: US 2007/0071190 A1
(43) Pub. Date: Mar. 29, 2007

(54) Facsimile apparatus

(75) Inventor: Toshiaki Denpo, Nagoya-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/475,187

(22) Filed: Jun. 27, 2006

(30) Foreign Application Priority Data
Jun. 27, 2005 (JP) 2005-186432

(51) Int. Cl. H04M 11/00

(52) U.S. Cl. 379/93.09

(57) ABSTRACT

A facsimile apparatus that includes: a main device; an additional device; an item setting part that sets items of operational condition of the main device recognizable through the additional device; an information generating part provided in the main device and generating information of the operational condition of the main device; an information transmitting part that transmits information corresponding to the items set by the item setting part; and an information output part provided in each additional device and outputting the transmitted information to notify a user when the additional device receives the information of the operational condition of the main device.

### CROSS REFERENCE TO RELATED APPLICATION

This application claims priority from Japanese Patent Application No. 2005-186432, filed on Jun. 27, 2005, the entire subject matter of which is incorporated herein by reference.

### TECHNICAL FIELD

Aspects of the present invention relate to a facsimile apparatus, which includes amain device connected with a telephone line and adopted to perform telephone communication or fax communication with a remote side connected through the telephone line and at least one additional device that performs wireless telephone communication or data communication with the main device, and particularly relate to a facsimile apparatus in which operation condition of a main device can be checked through a cordless additional device.

### BACKGROUND

Conventionally, a digital multifunction apparatus that functions as a printer, copy machine, scanner, and facsimile has been on the market. The multifunction apparatus is a digital facsimile apparatus controlling in combination each of components, i.e., a document-reading unit, an image-forming unit and a fax communication unit, or controlling the components separately, depending on usage. Thus, the multifunction apparatus may be regarded as a versatile facsimile apparatus.

In recent years, a facsimile apparatus having one or more cordless additional devices has been on the market.

In such an apparatus, the cordless additional device performs wireless communication with a main body of the multifunction apparatus (hereafter, referred to as main device). For example, a user who usually makes a phone call at various places in a home or shares a phone with other family members may want to add further additional devices and dispose them at places where the user makes a phone call other than the place where the main device is disposed. Thereby, the convenience of the apparatus can be improved.

Generally, a cordless additional device has a display unit formed of a liquid crystal display. In a case where the display unit displays not only a telephone directory for searching a listed name and information of caller at incoming call but also information about an operational condition of a main device (for example, information with respect to errors in the main device or fax results, etc.), a user can monitor the main device at a place other than the place where the main device is disposd. Thereby, the convenience of the cordless additional device can be improved.

A related-art technology has been proposed, in which the display of the cordless additional device is not used for the original purpose, but for monitoring operational conditions of a main device.

For example, JP-A-5-207176 discloses a cordless phone system including a main device having fax function. The system records data with respect to a condition of a facsimile apparatus connected with the main device (for example, transmitting a fax or receiving a fax and out of paper) and data about the main device or data indicating that each cordless additional device is busy in a recording area. The system rewrites or reads the recorded data according to a request of a cordless additional device, and then transmits the data to the cordless additional device for display.

Further, JP-A-5-188683 discloses a similar technology, in which a wireless communication device that performs wireless communication with a main device monitors operational conditions of the main device. The disclosed copy-communication system includes a copy machine and a wireless phone, in which when the copy machine operates and a user inputs an order together with an extension number of the wireless phone, the copy machine transmits operational condition data including the number of residual sheets and types of errors to the wireless phone. A display unit of the wireless phone displays the transmitted data.

### SUMMARY

However, in a multifunction apparatus having cordless additional devices, which is configured such that a user may monitor an operational condition of a main device on a display unit of each cordless additional device, when a lot of data is displayed, a user has to scroll up and down the data to see desired information because the display area is generally small. Thus, it is probable that the user may not sufficiently use the monitoring function due to the troublesome operation.

For example, in the above-mentioned multifunction apparatus, information with respect to the operational condition of the main device includes operating results depending on each function and errors. The operating results includes, for example, communication results when it operates a fax (normal or error), recorded messages by an answering machine, residual memory capacitywhen it functions as a copy machine or facsimile apparatus after storing image data in a memory. The information about errors includes information on consumables including recording sheets, ink and toner for a printing unit, and information indicating that the replenishment of the consumable is necessary. Further, the occurrence of a sheet jam at a sheet conveying mechanism conveying sheets or documents, the need for replenishment of a photosensitive member or light sources, and mechanical structural errors due to damage or misalignment, may be included in the information about errors.

The information on the operational condition and errors relate to the main device and they should be displayed on the display of the main device; however, the cordless additional device may display information that a user wants to know. When the cordless additional device displays the same information as that displayed on the main device, the user has to select desired information from the operational condition information and error information in order to obtain desired information. This operation is quite troublesome.

When each cordless additional device is disposed at difference places and, for example, used by each person of a family, each of them may want to monitor different information. Thus, it is preferable that each cordless additional device is set to monitor desired information.

According to the technology disclosed in JP-A-5-207176, preset kinds of operational condition data about the facsimile apparatus connected to the main device (for example, transmitting a fax, receiving a fax, out of paper, etc.) is recorded in the recording area. When the data changes, the changed data is read out from the recording area and is displayed on the display unit. This technology does not enable the users to selectively display desired data from the operational condition data for each of the cordless additional devices.

According to the technology disclosed in JP-A-5-188683, items of data about operational condition are preset in a data format of data available in communication between the main device and the cordless additional device, and the formatted data is used in the communication between the main device and the cordless additional device. This technology also does not enable the users to selectively display desired data from the operational condition data for each of the cordless additional devices.

Aspects of the present invention provide a facsimile apparatus having a cordless additional device, in which the apparatus allows users to set desired information for each cordless additional device and to monitor operational conditions of a main device through each cordless additional device.

### BRIEF DESCRIPTION OF THE DRAWINGS

FIG. 1 is a schematic perspective view showing a facsimile apparatus having cordless additional devices according to an aspect of the invention;

FIG. 2 is a cross-sectional view taken along line II-II of FIG. 1;

FIG. 3 is a functional block diagram showing the configuration of the facsimile apparatus;

FIG. 4 is a flowchart showing a process of setting, at a main device, items of operational condition to be displayed through each cordless additional device;

FIG. 5 is a flowchart showing a process of setting, at the cordless additional device, items of operational condition to be displayed through the each cordless additional device;

FIG. 6 is a flowchart showing a process when a paper tray is out of paper during image recording in the main device;

FIG. 7 is a flowchart showing a process in a cordless additional device when the main device informs the cordless additional device that the paper tray is out of paper;

FIG. 8 is an example of warning message ‘out of paper’ in a cordless additional device;

FIG. 9 is a flowchart showing a process in the main device that is in standby state when a remote side facsimile apparatus faxes and the main device normally receives fax data;

FIG. 10 is a flowchart showing a process in the cordless additional device when the main device informs the cordless additional device ‘fax receiving completed’;

FIG. 11 is an example of a message indicating ‘fax receiving completed (without information of a caller)’ in the cordless additional device; and

FIG. 12 is an example of a message indicating ‘fax receiving completed (with information of a caller)’ in the cordless additional device.

### DETAILED DESCRIPTION

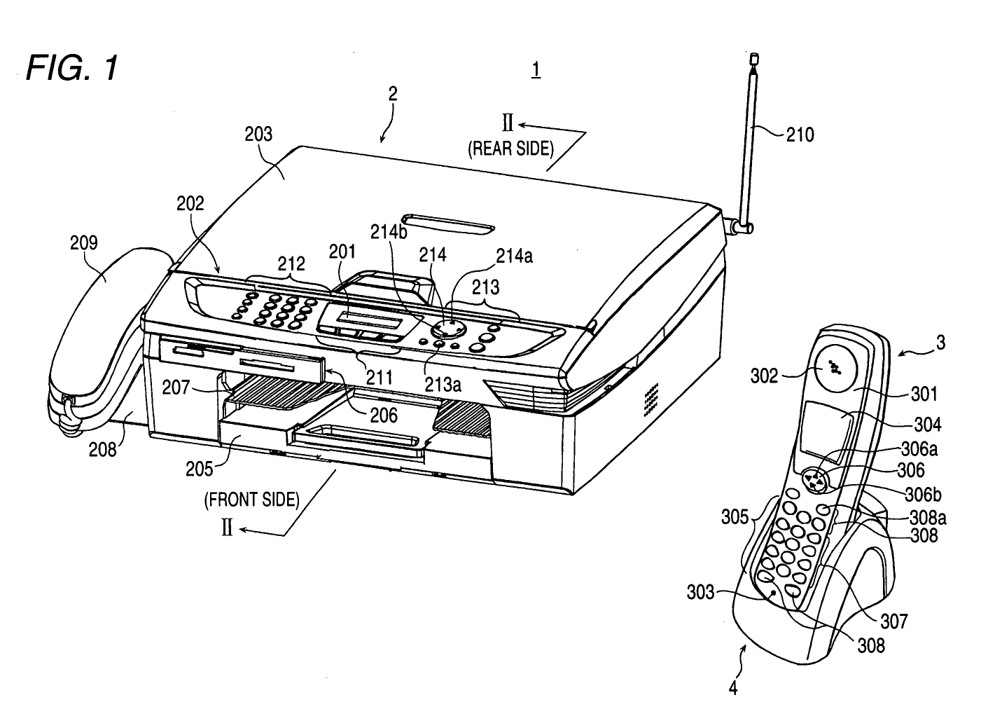

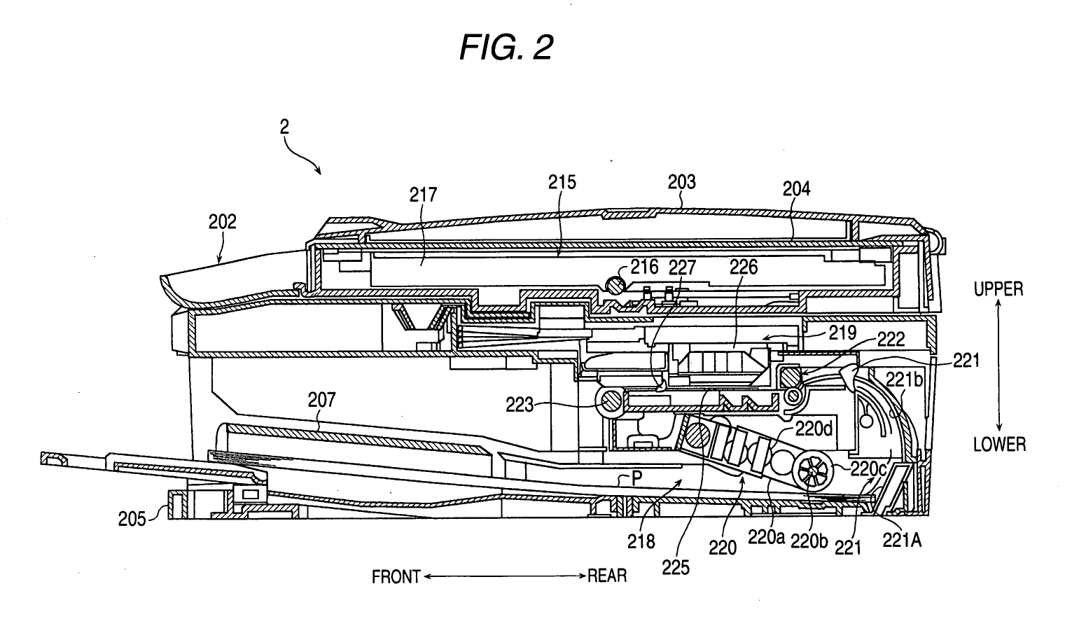

FIG. 1 is a perspective view showing a facsimile apparatus having cordless additional devices according to an aspect of the invention. FIG. 2 is a vertical cross-sectional view of the facsimile apparatus.

A facsimile apparatus 1 shown in FIGS. 1 and 2 includes a main device 2, which functions as a printer, a copy machine, a scanner machine, a fax machine, and photo media capturing. The facsimile apparatus further includes three cordless additional devices 3. In FIG. 1, only one cordless additional device 3 is illustrated.

The facsimile apparatus 1 may function as a printer by connecting it with a personal computer (hereafter, PC). The copy function is duplicating information of a document or a book. The scanner function is converting the information of a document or a book into image data. The fax function is sending image data converted from the information of a document to a remote side facsimile apparatus through a telephone line in accordance with the facsimile apparatus communications standards and receiving image data from the remote side facsimile apparatus and recording it on a sheet of paper. The photo media capturing function is, for example, creating a picture by reading out image data from an external memory storing the image data taken by a digital camera.

In this aspect, although the three cordless additional devices 3 are used, the number of cordless additional devices is optional. In the main device 2, a telephone communication function of the cordless additional device 3 is also optional. A user may selectively install the desired number of cordless additional devices for the main device 2.

The main device 2 is shaped into a low box and includes an operating panel 202 having a display unit 201 on the upper front. The main device further includes a cover 203 that opens and closes behind the operating panel 202; and a document-placing plate 204 disposed under the cover 203, where a document to be read is put on (FIG. 2). The document-placing plate 204 is formed of a transparent glass plate and is available for paper A4 sizes or smaller. In this aspect, when there are plural documents, each document is placed on the document-placing plate and read one-by-one. As described later, the read data from each document is stored in a memory and then, for example, faxed or duplicated after all the document's image data is stored in the memory. When an automatic document feeder is used instead of the cover 203, plural documents can be successively read.

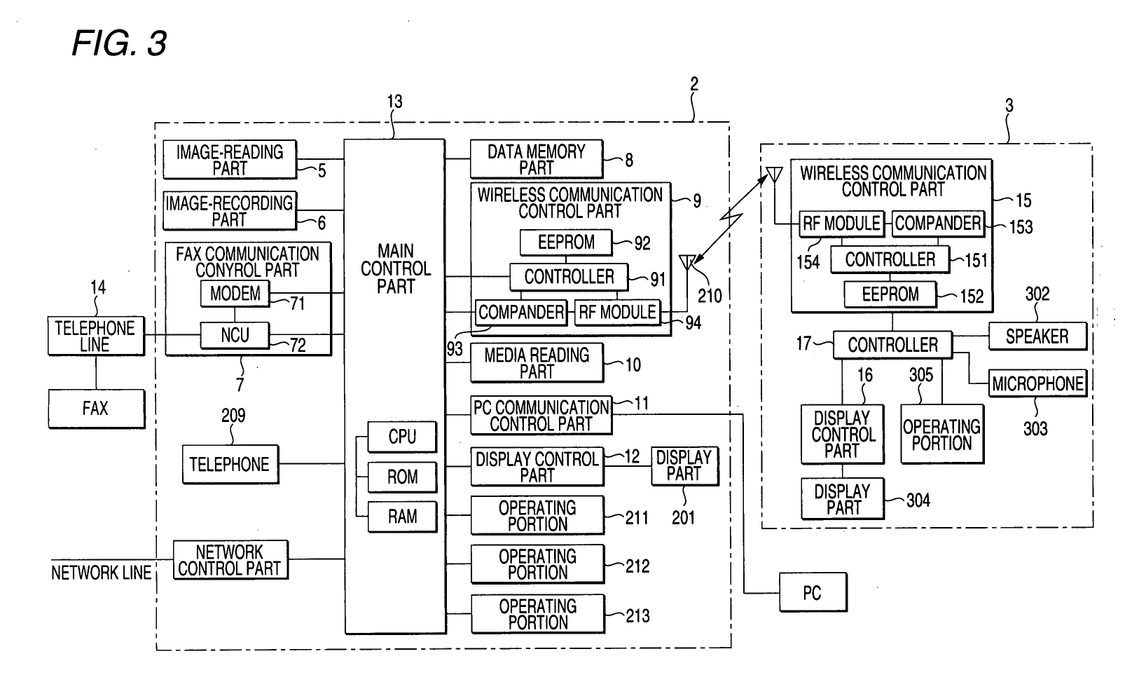

A paper feed tray 205 is provided at the lower-front portion of the main device 2 detachably. A paper discharge tray 207 is provided over the paper feed tray, which receives paper to be discharged out of the main device after the paper supplied from the paper feed tray is reversed and an image is formed on it. Further, a media attaching portion 206 is provided at the left upper portion at the front of the main device 2. An external memory storing image data taken by a digital camera is inserted into the media attaching portion 206. A switch (for example, push switch) positioned in the main device 2 detects whether the paper feed tray 205 is completely mounted. A signal indicating on/off of the switch is input into a main controller (described below, see FIG. 3) that mainly controls operation of the main device 2.

For example, when the switch is on, the main controller determines that the paper feed tray 205 is mounted, and when the switch is off, the main controller determines that the paper feed tray 205 is not mounted. When determining that the paper feed tray 205 is not mounted, the main controller displays on the display unit 201 a predetermined warning message informing a user that the paper feed tray 205 is not mounted. Similarly, a switch in the media attaching portion 206 detects whether the external memory is inserted, and the detected signal is input into the main controller. When determining that the external memory is not inserted in the media attaching portion 206 in a photo media capturing mode, the main controller displays a predetermined warning signal on the display unit 201 informing that the external memory is not inserted.

An opening is formed at the bottom of the paper feed tray 205. The main device is provided with are flective optical sensor (hereafter, paper detecting sensor) at a position facing the opening. The paper detecting sensor detects whether the paper feed tray is out of paper when it is mounted into the main device 2. When receiving a signal (for example, high-level signal) indicating that the paper detecting sensor receives light reflected from paper, the controller determines that paper is in the paper feed tray. In contrast, when receiving a signal (for example, low-level signal) indicating that the paper detecting sensor does not receive light reflected from paper, the controller determines that the paper feed tray is empty.

A receiver seat 208 is attached to the left of the main device 2. A receiver 209 is placed on the receiver seat 208. A user can make a phone call through an extension or an outside line using the receiver 209. A rod-shaped antenna 210 is attached to the right rear of the main device 2. The antenna 210 is extendable and performs a wireless phone call or data communication with the additional device 3. A connector for connecting a PC (for example, USB (Universal Serial Bus) connector), not shown in FIG. 1, is installed at the back of the main device 2. When a PC is connected to the connector, the main device 2 may function as a printer for the PC.

The display unit 201 at the center of the operating panel 202 is a liquid crystal display (LCD) including a plurality of pixels forming a matrix. The display unit is sized such that it displays three lines of predetermined sized characters. The display unit 201 displays various information using half-width katakana characters or half-width alphanumeric characters in each line. For example, at any time and any operating mode, the display unit displays various configuration (for example, the recipient's name and phone number in a fax mode, and the number of paper to be copied and a density value, etc., in a copy mode), operational condition (for example, a transmitting or receiving result in a fax mode, a copy result in a copy mode), and an error or warning message, etc.

Operating portions 212, 213, 211 having a plurality of buttons, respectively, are formed at the left and right of the operating panel 202 and under the display unit 201. The operating portion 211 under the display unit 201 is for setting each mode, i.e. a fax, copy, scan, or a photo media capturing mode, and has four mode setting buttons corresponding to the four operating modes.

The initial mode of the main device 2, when power is switched on, is the fax mode. A user can change the fax mode to a desired mode of copy, scan, or photo media capturing by pressing the desired mode setting button. Further, in a case where a PC is connected to the main device 2, the operating mode is changed to a print mode when the PC sends a print-requesting signal, and the operating mode automatically returns to the previous mode after printing is performed by interrupt process.

The operating portion 212 at the left in the operating panel 202 includes sixteen buttons for performing operations related to the telephone. Four of those buttons control on/off power, redialing, and on-hook, etc. and are arranged at the left side. The other twelve buttons arranged at the right side are numerical keypads for inputting numbers such as a phone number, etc. using them. The keypads also function as input keys, for example, for katakana or alphabetical characters.

The operating portion 213 at the right in the operating panel 202 mainly relates to image-recording or setting various parameters with respect to each operating mode. Six buttons and one arrow key 214 are provided. Three buttons for instructing stop copy, color copy, and monochrome copy are arranged in a column at the right side. The arrow key 214 is positioned at the right in the display unit 201 and the other three buttons are for selecting an item with respect to the parameters in each operating mode and are arranged in a row under the arrow key.

An operating button 213a (hereafter, menu/set button) is provided at a center under the arrow key 214 and used to display a menu or complete selecting an item included in the menu. As described below, in the facsimile apparatus 1 including cordless additional devices of this aspect, an item, which is displayed on a display unit 304 of the cordless additional device 3, with respect to the main device's operational condition may be selectively set by the cordless additional device 3. The selecting/setting of the display item of the condition of the main device 2 for each additional device 3 is included in the menu. When the menu/set button 213a is pressed, a part of the menu is displayed. The items in the menu are arranged in a layer structure. When more than three items are included in one layer, the first to third items are displayed on the display unit 201.

The arrow key 214 functions as a scroll key to display the other part (the items not displayed but in the same layer) not shown in the menu displayed on the display unit 201 and functions as a select key for a user to select a desired item of the three items (an item in a layer not displayed). A user scrolls the menu and selects an item using upper and lower buttons 214a, 214b in the arrow key 214. The display item regarding the condition of the main device 2 for each additional device 3 is also displayed on the display unit 201 by operating the upper and lower buttons 214a, 214b. The selection of display items, about the operational condition of the main device 2, for each additional device 3 is also done through the arrow key 214. By operating the upper and lower buttons 214a, 214b, the display items are displayed on the display unit 201.

In other words, when the menu/set button 213a is pressed, the first to third items of the uppermost layer are displayed in three lines at the display unit 201. A selected item of the three items is highlighted. The items in the uppermost layer are scrolled down one-by-one by pressing each time the key 214b of the arrow key 214, and then new items to be selected are displayed. When the upper key 214a of the arrow key 214 is pressed to scroll up, the items in the uppermost layer are scrolled up one-by-one, and then new items to be selected are displayed.

A user displays a desired item on the display unit 201 and selects an item by operating the keys 214a, 214b of the arrow key 214. Thereafter, the user operates the menu/set button 213a to complete the selection, and then the first to third items among several items included in the items to be selected is displayed in three lines on the display unit 201. A user may also select desired items in the other layers by repeating the above operating procedure.

As shown in FIG. 2, an image-reading unit 215 is positioned under the document-placing plate 204 in the main device 2. The image-reading unit 215 includes a guide bar 216 horizontally (left and right in FIG. 1) extending in the main device 2, an image scanner 217 movably installed horizontally along the guide bar 216, a driving unit (not shown) controlling the scanner's reciprocation, and a reading-control unit (not shown) that controls reading of a document.

The image scanner 217 is formed in a rode shape and is arranged such that its longitudinal direction (in the front and rear direction of the main device 2) is perpendicular to the guide bar 216. The image scanner 217 is a CSI type (Contact Image Sensor) scanner, which is configured by integrally forming light sources LEDs of R (red), G (green), and B (blue), an image sensor that is a CCD line sensor receiving light irradiated from the light source and reflected from a document, and a bar-shaped rod lens array that concentrates the light reflected from a document to each pixel consisting of the CCD line sensor. The image scanner 217 reads out information of a document by sequentially receiving a light figure from the document on the document-placing plate 204 using the CCD line sensor, converting it into an image data, and repeating this procedure while reciprocating left and right in the main device 2 (hereafter, sub scanning direction). The light figure is a linear light figure of the document on which light is irradiated from each of the light sources of R, G, and B in the front and rear direction of the main device 2 (hereafter, main scanning direction).

Specifically, the image scanner 217 repeats the light-receiving and image data-converting operations by moving per line in the sub scanning direction and repeatedly reads out image data from each pixel sequentially in the main scanning direction and stores them in a memory (not shown). When reaching the end in the sub scanning direction, the image scanner 217 finishes reading out a document and returns to a predetermined home position.

A paper conveying mechanism 218 is mounted in the main device 2, which takes staked paper in the paper feed tray 205 at the bottom of the main device 2 one-by-one, sends and turns over it at the rear of the main device 2, thereafter, sends it to the front of the main device 2 to the paper discharge tray 207. An image-recording unit 219 is provided at a predetermined position under the image-reading unit 215 in a conveying path of the paper-conveying mechanism 218 to the paper discharge tray 207 and records an image on paper.

The paper-conveying mechanism 218 includes a pick-up unit 220 that picks up paper P stacked in the paper feed tray 205 one-by-one from the top and sends it to the rear side of the main device, turning-over guide 221 that turns over and inverts the paper sent by the pick-up unit 220, a registration roller 222 that corrects a skew of the paper inversed by the turning-over guide 221 and synchronizes it with an image-forming operation of the image-recording unit 219, and a discharging roller 223 that discharges the paper with the image by the image-recording unit 219 onto the paper discharge tray 207.

The pick-up unit 220 is positioned close to the rear side of the paper feed tray 205 at the bottom of the main device 2. The unit 220 includes a pair of arms 220a that is held at a predetermined height from the bottom of the main device 2 and is capable of pivoting while extending to the rear side at an inclined angle, a shaft 220b that is suspended between the ends of the pair of arms 220a, and a plurality of pick-up rollers 220c fitted to the shaft 220b.

A driving force transmission mechanism 220d including a plurality of gears engaged to each other is provided for one of the arms 220 to transmit rotational force to the shaft 220b connected with the rollers 220c. A driving force of a motor (not shown) is transmitted to a base gear. The pick-up rollers 220c rotate counterclockwise in FIG. 2 by the motor's driving force transmitted through the driving force transmission mechanism 220d. Accordingly, paper P stacked in the paper feed tray 205 is conveyed to the rear one-by-one from the top.

The turning-over guide 221 includes a inclined-separating plate 221a disposed behind the pick-up unit 220 at the bottom of the main device 2 and a pair of curved guide plates 221b over the inclined-separating plate 221a. The inclined-separating plate 221a has a convex shape with the center in a width direction (perpendicular to the sheet of FIG. 2) protruding forward in a curved manner. A separating pad, i.e. a serrated elastic member, is fixed to the center. When more than one piece of paper P are conveyed by the pick-up rollers 220c, the separating pad is brought into contact with the leading edge of the paper and separates a sheet of the uppermost paper P, and the separating plate 221a then sends it downstream.

The guide plate 221b sends the paper P separated by the separating pad of the inclined-separating plate 221a upward while inverting it. The registration roller 222 is positioned at an end of the guide plate 221b (position above the pick-up roller 220c). The registration roller 222 has a pair of driving and driven rollers. A sensor 224 detecting the conveyance of paper P is provided at a predetermined position upstream of the registration roller 222.

The sensor 224 (hereafter, paper-feeding sensor) is, for example, a lever switch having a pivot lever. The lever switch is normally on, but it is off when paper P is conveyed, and its leading end presses down the lever more than a predetermined angle. A signal indicating the lever switch's on/off is input to the main controller in the main device 2. After the pick-up unit 220 starts to convey the paper P, when the lever switch is not turned on within a predetermined time, the main controller determines that the paper conveyance has failed (hereafter, paper jam A) and displays a predetermined error message on the display unit 201 to inform a user of paper jam A.

The image-recording unit 219 is positioned at the downstream side of the registration roller 222. The image-recording unit 219 includes a platen 225 that is positioned at the same level as a paper-discharging position of the registration roller 222, an inkjet type printer head 226 that is movable along the guide bar 216 extending in the width direction of the main device 2 (left and right in FIG. 1), an ink cartridge (not shown) supplying ink to the printer head 226, and a recording controller (not shown) controlling the recording onto the paper.

The platen 225 is a plate having substantially the same size as the width of the A4 size paper and horizontally positioned in the main device 2. The printer head 226 has four nozzles arranged in a line along the length of the main device. Eject surfaces of the nozzles are arranged at predetermined intervals and face the platen 225. The nozzles of the printer head 226 are supplied with magenta (M), cyan (C), yellow (Y), and black (BK) ink from the ink cartridge, respectively.

The ink cartridge is configured by integrally forming four cubic ink tanks and is fixed at a predetermined position in the main device 2. Each tank stores magenta (M), cyan (C), yellow(Y), or black(BK) ink. Each ink tank of the ink cartridges is connected with a corresponding nozzle of the printer head 226.

The recording controller (not shown) manages the residual ink in each ink tank of the ink cartridge. A fixed quantity of the ink is ejected from each nozzle at one time. Thus, the recording controller counts the number of ejecting times of each nozzle for every recording; calculates the used and residual ink in each ink tank from the counted value, the amount of ink/jetting, and the full amount of the ink; and stores the result in its memory. The recording controller determines which ink tank has an amount of residual ink less than a predetermined value and also stores this result in the memory.

The recording controller starts to record when the paper P reaches a predetermined position of the platen 225 by the registration roller 222. The recording controller forms an image line by controlling the printer head to reciprocate in the sub scanning direction and the nozzle of each color to eject the ink on the paper P on the basis of the image data of each color received from the main controller. The registration roller 222 conveys the paper P per line when the printer head 226 reaches the end in the sub scanning direction. The recording controller reverses the printer head 226 when it reaches the end in the sub scanning direction and forms image line, as in the previous movement, by controlling the nozzle of each color to eject the ink on the paper P on the basis of the image data of each color received from the main controller, and the image is formed on the whole paper P.

The discharge roller 223 includes a pair of driving and driven rollers, positioned at the downstream side of the platen 225. The paper P formed with an image is discharged onto the paper discharge tray 207 by the discharge roller 223.

A sensor 227 (hereafter, paper-discharging sensor), which is the same as the sensor 224, is provided in a proper position between the downstream of the platen 225 and the paper discharge roller. A signal output from the discharging sensor 227 is also input into the main memory. The main controller determines that the paper discharge has failed (paper jam B) when the lever switch is not turned on even though the paper P has been discharged at more than the predetermined amount by the registration roller 222. When the paper discharge has failed, the main controller displays a predetermined error message on the display unit 201 to inform a user of paper jam B.

A circuit board (not shown) is provided with a circuit unit that allows fax, photo media capturing, and telephone communication functions by the cordless additional device 3, even though they are not shown in FIG. 2.

Returning to FIG. 1, the cordless additional device 3 includes an additional device body 301 that has a longitudinal rectangular parallelepiped shape and is curved in a ‘V’ shape. The additional device body 301 is placed on a charging stand 4 when not used. The charging stand 4 has a recess for detachably placing the additional device body 301, which is longitudinally deposited by inserting its lower part into the recess. The charging stand 4 has a charging circuit therein for charging a battery built in the additional device body 301 and the cordless additional device 3 is charged when deposited in the charging stand 4.

The additional device body 301 has a speaker 302 at its upper interior that reproduce the recipient's voice in a telephone communication and a microphone 303 at the lowest portion to take the user's voice. In addition, a display unit 304 formed of an LCD (Liquid Crystal Display) is mounted between the curved portion of the additional device body 301 and the speaker 302. An operating part 305 including several buttons is formed between the curved portion and the microphone 303.

The display unit 304 has dimensions capable of displaying four lines of predetermined sized characters. Information including a recipient's name, phone number, etc. is displayed in three lines from the top in the display area using half-width katakana characters or half-width alphanumeric characters of each line, and in last one line the attribute information accompanied by the recipient or the phone number using pictograms is described. The attribute information refers, for example, to group identification or the type of the phone numbers, such as cellular phone, facsimile apparatus, company telephone, or home telephone, listed in a phone directory when the recipients are classified.

The operating part 305 includes an arrow key 306 having the same function as the arrow key 214 of the main device 2. Numerical keypads 307 includes twelve buttons for inputting characters when a user lists the recipient's information using half-width katakana characters or half-width alphanumeric characters. Operating buttons 308 including seven buttons for required. operations in a telephone communication using the cordless additional device 3. The required operation includes, for example, the operation for a phone call through an extension or an outside line, redialing, holding conversation, volume control of the speaker 302, and hanging up, etc. Among the operating buttons 308, the buttons 308a (hereafter, menu/set button 308a) disposed at the left and right of the arrow key 306 have the same function as the menu/set button 213a of the main device 2.

In the facsimile apparatus 1 having cordless additional devices according to the aspect, as described below, a user is capable of selecting/setting items of operational condition of the main device 2 for each cordless additional device 3 by the same operation as in the main device 2 by using the cordless additional device 3. In other words, a user can select/set items of the operational condition of the main device 2 by pressing the menu/set buttons 308a to display a menu and selecting ‘setting an item with respect to operational condition’ included in the menu with upper and lower keys 306a, 306b of the arrow key 306. In the same procedure as the main device, a user scrolls items displayed on the display unit 304 using the upper and lower keys 306a, 306b of the arrow key 306 and selects a desired item, thereafter, completes the selecting of an item by operating the menu/set buttons 308a.

FIG. 3 shows a block diagram illustrating the configuration of the facsimile apparatus 1 having cordless additional devices. The same reference numeral is given to the same part as in FIG. 2.

The function block for the main device 2 includes an image-reading part 5 that reads out the document, converts the read information into image data, and then outputs the result; an image-recording part 6 that prints on the basis of the image data and records the image on paper; a facsimile communication control part 7 that is connected to a telephone line, allows a telephone communication through an outside line using the receiver 209, and converts the image data into a transmitting signal (fax data) in accordance with the facsimile apparatus communications standards and transmits it to the recipient's facsimile apparatus; a data memory part 8 that stores the image data or voice data (message recorded in a telephone answering machine) transmitted from or received by the facsimile communication control part 7; a wireless communication control part 9 that controls the wireless communication or a telephone communication with the cordless additional device 3, a media-reading part 10 that reads image data from media inserted in the media attaching portion 206; a PC communication control part 11 that controls communication of a PC; a display control part 12 that controls displaying information on the display unit 201; and a main control part 13 that controls overall system including the image-reading part 5 to the image control part 12 on the basis of the information input from the operating portions 211 to 213.

The image-reading part 5 functions by the above-mentioned image-reading unit 215 and reads a document in accordance with an image-reading order signal of the from the main control part 13. The main control part 13 outputs the image-reading order signal to the image-reading part 5 when a copy mode is selected by the operating portion 213 during any of operating modes, i.e. fax, copy, or scan mode is set, using the operating buttons in the operating portion 211. The image data output from the image-reading part 5 by reading the document is stored in the data memory part 8 temporally and utilized to fax or form image on paper. The main control part 13 receives information on the operational condition of the image-reading part 5, for example, information of abnormal operation in the image scanner 217 or a driving unit for the image scanner 217, or an image-reading unit.

When receiving the information with respect to the abnormal operation of the image-reading part 5, the main control part 13 controls the display control part 12 to display an error message on the display unit 201 and at the same time also informs the cordless additional device 3 about the information.

The image-recording part 6 includes the above-mentioned paper feed tray 205, a paper discharge tray 207, a paper conveying mechanism 218, and the image-recording unit 219 and records an image onto paper in accordance with the image-recording order signal from the main control part 13. When the image-reading part 5 completes the image-reading in a state in which the operating mode is set to the fax mode or the copy mode, the main control part 13 designates image data to be recorded in the image-recording part 5 and outputs an image-recording order signal. The image-recording part 6 reads the image data designated by the main control part 13 from the image memory part 8 and forms an image onto paper on the basis of the image data.

The main control part 13 is informed of the operational condition of the image-recording part 6, for example, the paper feed tray 205 not completely mounted or out of paper, paper jam A and paper jam B, the residual amount of ink in the ink cartridge or the residual amount less than a predetermined amount (replenishing time of ink), and breakdown of hardware.

When receiving the information with respect to the operational condition of the image-recording part 6, in case the information is involved with a malfunction, the main control part 13 controls the display control part 12 to display an error message on the display unit 201, or in the case of the replenishment of consumables, a message requesting replenishment of it. The main control part 13 informs the cordless additional device 3 designated to display the error message or the message requesting replenishment of the consumables about the malfunction or the replenishment of the consumables.

The facsimile communication control part 7 includes a modem 71 that modulates digital data into a transmission signal, which can be transmitted through a telephone line 14, and demodulates the transmission signal transmitted through the telephone line 14 into digital data; and an NCU 72 (Network Control Unit) that controls transmitting and receiving a dial signal through the telephone line 14.

In the fax mode, when the image-reading part 5 reads the information of the document to be transmitted and all the information is stored in the data memory part 8, the main control part 13 sequentially reads out the image data from the data memory part 8 together with the recipient's phone number and transmits it to the facsimile communication control part 7. In the facsimile communication control part 7, the NCU 72 establishes the line connected with the recipient's facsimile apparatus, thereafter, the modem 71 modulates the image data into the fax signal and the modulated signal is transmitted to the recipient's facsimile apparatus through the NCU 72 and the telephone line 14.

The facsimile communication control part 7 informs the main control part 13 whether the image data has been normally transmitted to the recipient's facsimile apparatus (fax result information). The main control part 13 controls the display control part 12 to display the fax result information on the display unit 201 and sends the fax result information to the cordless additional device 3 designated to display the transmission results.

When receiving a signal with respect to the fax data, the facsimile communication control part 7 receives the fax signal from the recipient's facsimile apparatus through the telephone line 14 and NCU 72 after the NCU 72 establishes a line connected with the recipient's facsimile apparatus. The received fax signal is demodulated into a digital signal by the modem 71 and then stored in the data memory part 8 through the main control part 13. The facsimile communication control part 7 informs the main control part 13 about whether it can normally receives the image data from the recipient's facsimile apparatus (receiving result information). The main control part 13 controls the display control part 12 to display the receiving result information on the display unit 201 and sends the receiving result information to the cordless additional device 3 designated to display the receiving result.

In the main device 2, a user is able to make a phone call through an extension or an outside line by picking up the receiver 209 from the receiver seat 208 or pressing an off-hook button of the operating portion 212. When a user inputs the recipient's phone number in the off-hook state, the main control part 13 transmits the phone number to the facsimile communication control part 7 and makes a phone call to the recipient through the outside line. Meanwhile, after the device 2 is shifted to the off-hook state, when the button for an extension of the operating portion 212 is pressed and the number (ID number) assigned to the cordless additional device 3 is input, the main control part 13 transmits the cordless additional device's number to the wireless communication control part 9 and makes a phone call through an extension to the cordless additional device 3 having the number.

When the facsimile communication control part 7 receives a signal through an outside line, the main control part 13 rings a bell. When a user picks up the receiver 209 and the receiver shifts to the off-hook state, the main control part 13 allows the user to have a telephone communication with a caller through an outside line. In a case where an answering machine is set through the buttons of the operating portion 212, the main control part 13 stores a message from a caller in the data memory part 8 after rings a bell predetermined times.

The data memory part 8 is capable of storing hundreds of pages of image data (for example, 400 to 500 pages) received by a facsimile apparatus. The data memory part 8 is utilized to store the image data read by the image-reading part 5 in the copy, scan, and fax modes (transmission mode) for a predetermined time and to perform alternative reception in a fax mode (receiving mode). The data memory part 8 is also utilized to store a message from a caller when an answering machine is set. Therefore, the data memory part 8 has independent areas for image data and voice data.

The available capacity of the data memory part 8 is managed by the main control part 13. In other words, the main control part 13 calculates the available capacity by subtracting the amount of image data and voice data from the capacity of the data memory part 8 every time it stores the image data and voice data. Further, the main control part 13 compares the calculated available capacity to a predetermined critical value and determines whether it is below the predetermined critical value. Thereafter, when the available capacity is below the predetermined value, the main control part 13 controls the display part 12 to display a message informing a user about it on the display unit 201.

The wireless communication control part 9 includes a controller 91 formed of a microcomputer having a CPU (Central Processing Unit), ROM (Read Only Memory), and RAM (Random Access Memory); EEPROM 92; a compander 93; and a RF module 94.

The EEPROM 92 stores data required for the wireless communication with the cordless additional device 3, such as the cordless additional device's ID number (for example, the number assigned to the cordless additional device). The compander 93 inputs a voice signal or data signal to be modulated to the RF module 94 for generating a signal to be transmitted from the main device 2 to the cordless additional device 3. The compander 93 outputs a voice signal out of the cordless additional device 3, which is received and demodulated by the RF module 94 and outputs a data signal to the controller 91.

The data signal transmitted from the main device 2 to the cordless additional device 3 includes a data signal for establishing the communication with the cordless additional device 3 and a data signal (for example, information with respect to the operational condition of the main device 2, or the recipient's phone number in the case of having a number displaying function) to be displayed on the display unit 304 of the cordless additional device 3. The controller 91 takes information with respect to the main device 2, such as the operational condition of the main device 2, from the main control part 13 and inputs it to the compander 93, while the voice signal from the main device 2 in a conversation through an extension or an outside line is directly input from the main control part 13 to the compander 93. In contrast, a data signal output from the compander 93 is input to the controller 91 and transmitted from the controller 91 to the main control part 13 if needed. A voice signal output from the compander 93 is directly input to the main control part 13.

The RF module 94 has a transmitting circuit that allows the main device 2 to transmit a voice signal or data signal to the cordless additional device 3 and a receiving circuit that allows the main device 2 to receive a voice signal or data signal from the cordless additional device 3. The transmitting circuit is capable of generating eighty nine carrier frequencies of 380 MHz band width, and a data signal is transmitted through two carried frequencies (hereafter, first control channel) among them and the other frequencies (hereafter, first telephone communication channel) are for a voice signal. Specifically, the RF module 94 selects an available channel of the first two control channel, modulates it into the data signal from the compander 93, and transmits the modulated signal to the cordless additional device 3 through an antenna 210. The RF module 92 also selects available channels of the remaining eighty seven first telephone communication channels, modulates the selected first telephone communication channel into the voice signal out of the compander 93, and transmits the voice signal to the cordless additional device 3 through the antenna 210.

The receiving circuit is capable of receiving eighty nine carrier frequencies of 280 MHz band width, the data signal transmitted from the cordless additional device 3 is transmitted through two carried frequencies (hereafter, second control channel) among them and the other frequencies (hereafter, second telephone communication channel) are for the voice signal transmitted from the cordless additional device 3. Specifically, the RF module 94 receives the second control channel transmitted from the cordless additional device 3, demodulates the data signal, and inputs it to the compander 93, and also receives the second telephone communication channel transmitted from the cordless additional device 3, demodulates the voice signal, and inputs them to the compander 93. The compander 93 inputs the data signal input from the RF module 94 to the controller 91 and transmits the voice signal input from the RF module 94 to the main control part 13.

The display control part 12 controls the display of the information (code data) input from the main control part 13 on the display unit 201. The display control part 12 includes a table converting the code data into katakana characters, alphabetic characters, numerals, and pictograms, therefore, converts the code data input from the main control part 13 into the above-mentioned characters and displays them at a predetermined position in the display unit 201 on the basis of the control signal input from the main control part 13.

The main control part 13 is formed of a microcomputer including a CPU, ROM, and RAM and allows the fax, printer, copy, scan, photo media capturing, or wireless telephone function through composite controlling of the image-reading part 5 to display control part 12 on the basis of the information input by the operating portions 211 to 213.

The ROM stores programs for the fax, print, copy, scan, photo media capturing, and phone modes through the cordless additional device 3 or the receiver 219 of the main device 2 and required data for processing the programs. The RAM is used as an operational memory for the CPU to compute on the basis of the processing program stored in the ROM. Although the data memory part 8 is shown as a separate part from the RAM in FIG. 3, it may be installed in the RAM of the main control part 13.

The main control part 13 allows the main device 2 of the fax function by controlling each component in the image-reading part 5, the image-recording part 6, the facsimile communication control part 7, and the data memory part 8 in the fax mode. The copy function is achieved by controlling each component in the image-reading part 5, image-recording part 6, and data memory part 8 in the copy mode. The scan function is achieved by controlling each component in the image-reading part 5 and data memory part 8 in the scan mode. The photo media capturing function is achieved by controlling each component in the media-reading part 10, data memory part 8, and image-reading part 6 in the photo media capturing mode. Furthermore, the main control part 13 allows the main device to print by controlling each component in the PC communication part 11, data memory part 8, and image-recording part 6, and to communicate by telephone by controlling each of the wireless communication control part 9 and the facsimile communication control part 7.

The configuration block for the cordless additional device 3 includes the wireless communication control part 15 that controls the wireless communication and the telephone communication with the main device 2, the display control part 16 that controls the display of information on the display unit 304, the control part 17 that controls each component in the wireless communication control part 15 and the display control part 16 on the input information through the operating portion 305.

The wireless communication part 15 includes the controller 151 having the microcomputer having a CPU, ROM, and RAM; the EEPROM 152; the compander 153; and the RF module 154. The function of the controller 151, the EEPROM 152, the compander 153, and the RF module 154 is the same as that of the controller 91, the EERROM 92, the compander 93, and the RF module 94 of the main device 2; and thus a detailed description will be omitted. The transmitting circuit of the RF module 154 is capable of generating eighty nine carrier frequencies of 280 MHz band width and transmits a data signal and a voice signal to the main device 2 through the second control channel and the second telephone communication channel, respectively. Further, the receiving circuit of the RF module 154 is capable of generating eighty nine carrier frequencies of 380 MHz band width. The receiving circuit receives the data signal and the voice signal from the main device 2 through the first control channel and the second telephone communication channel, respectively.

The display control part 16 controls the display of the input information (the code data) from the control part 17 on the display unit 304. The display control part 16 includes a table converting the code data into katakana characters, alphabetic characters, numerals, and pictograms. The display control part 16 converts the code data input from control part 17 into the above-mentioned characters and displays them at a predetermined position in the display unit 304 according to the control signal input from the control part 17.

A process of selective display of the operational condition of the main device 2 through each cordless additional device 3 will be described hereinafter.

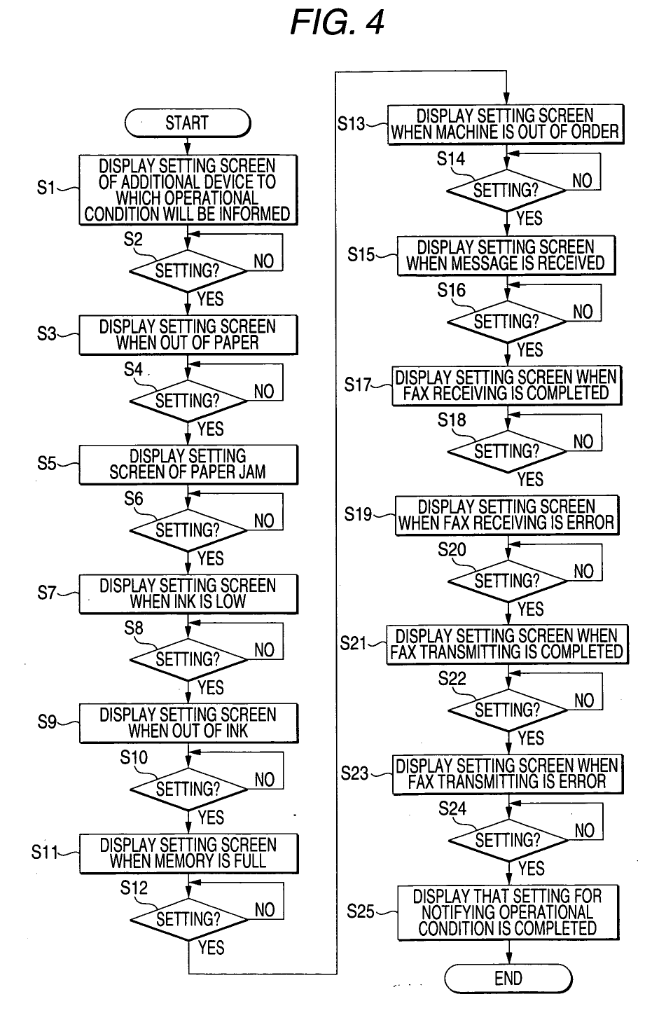

A processing order of setting items with respect to the operational condition for each cordless additional device 3, performed on the main device 2, is described with reference to a flow chart shown in FIG. 4. Further, the following cases are takenas examples, (a) out of paper, (b) paper jam, (c) low residual ink, (d) no residual ink, (e) store rejection, (f) machine error, (g) recording message, (h) fax receiving completed, (i) facsimile receiving error, (j) fax completed, and (k) selectively setting whether display of the eleven fax errors on the display unit 304 of each cordless additional device 3.

Incidentally, “(a) out of paper” is the state where the paper feed tray 205 is out of stacked paper P “(b) paper jam”is the sate where the paper jam A or B occurs; “(c) low residual ink” is the state where the residual ink in each of the magenta cyan, yellow, and black ink tank is less than a predetermined value; “(d) no residual ink” is the state where the ink in each of the magenta, cyan, yellow, and black ink tanks has been used up; “(e) store rejection” is the state where the data memory part 8 is full of data; “(f) machine error” is the state where mechanical configuration of the main device 2 is damaged; “(g) recording message” is the state where a message from a caller is stored in the data memory part 8; “(h) fax receiving completed” is the state where fax data has been normally received; “(i) facsimile receiving error” is the state where fax data has been received but with errors; “(j) fax completed” is the state where fax data has been normally received; “(k) fax error is the state where fax data has been transmitted, but the cordless additional device 3 is informed that an error has occurred.

A user presses the menu/set button 213a in order for the menu to be displayed on the display unit 201, selects ‘setting a display item of the operational condition of the main device’ by operating the arrow key 214, and then presses again the menu/set button 213a to complete the selecting of an item. The process in FIG. 4 is carried out in this procedure.

A title message ‘selecting a cordless additional device’ and a message ‘cordless additional device A/cordless additional device B/cordless additional device C/all cordless additional devices’ for selecting a cordless additional device are initially displayed in the first and second lines in the display area of the display unit 201, respectively (S1). In that case, when a user operates the right key in the arrow key 214 the items are highlighted in the order of ‘cordless additional device A’→‘cordless additional device B’→‘cordless additional device C’→‘all cordless additional devices’→‘cordless additional device A’, cycling to the right. When a user operates the left key the items are activated in the order of ‘cordless additional device A’→‘all cordless additional devices’→‘cordless additional device C’→‘cordless additional device B’→‘cordless additional device A’, cycling to the left. Therefore, the user may complete the selecting of a cordless additional device by pressing the menu/set button 213a while highlighting a desired cordless additional device by operating the left or right key in the arrow key 214 (S2). For example, when a user highlights the ‘cordless additional device A’ and presses the menu/set button 213a, the cordless additional device A is selected, and an item of the operational condition of the main device is selected and set with respect to the cordless additional device A in steps S3 to S25.

Even though the three cordless additional devices are displayed in advance as an object to be selected and a desired additional device 3 of them is selected, a user may input the cordless additional device's number. Accordingly, a user may easily select two arbitrary cordless additional devices associated at his option or all the three cordless additional devices.

After a user selects the cordless additional device A for the setting of an item of the operational condition, a title ‘notification of out of paper’ is displayed in the first line of the display area of the display unit 201 and a message ‘notify/not notify’ for determining whether to inform the cordless additional device A of the condition is displayed in the second line (S3). In this case, when a user operates the left or right key in the arrow key 214 the items are highlighted in the order of ‘notify’→‘not notify’→‘notify’, cycling either to the left or right. Therefore, the user may set the main device whether to inform the cordless additional device A that there is no paper, by pressing the menu/set button 213a while highlighting a desired operation through operating the left or right key in the arrow key 214 (S4). For example, in a case where a user highlights the ‘notify’ and presses the menu/set button 213a, the main device is set to inform the cordless additional device A that paper has been used up.

In the same procedure as described above, titles ‘notification of paper jam’, ‘notification of low residual ink’, ‘notification of no residual ink’, ‘notification of memory rejection’, ‘notification of machine error’, ‘notification of recording message’, ‘notification of fax receiving completed’, ‘notification of facsimile receiving error’, ‘notification of fax completed’, and ‘notification of fax error’, and a message ‘notify/not notify’ are displayed in this order on the display unit 201 (S5, S7, S9, S11, S13, S15, S17, S19, S21, S23). A user sets whether to display each item in the cordless additional device A by repeatedly operating the left or right key of the arrow key 214 with respect to each item and the menu/set button 213a (S6, S8, S10, S12, S14, S16, S 18, S20, S22, S24). This setting is stored in the RAM of the main control part 13.

When a user sets whether to display last item ‘notification of fax error’, a message ‘The notification of operational condition is completely set’ is displayed in the display area of the display unit 201 for a preset time (for example, 5 seconds) (S25). The setting of the items of the operational condition for each cordless additional device 3 is completed.

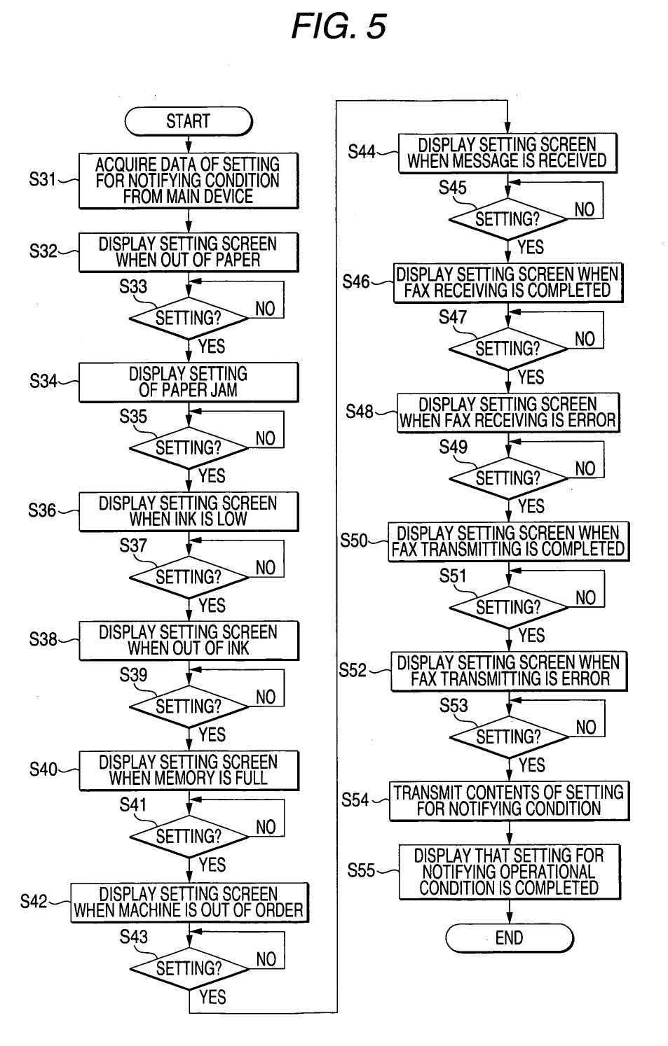

Hereinafter, a processing order of setting items of the operational condition to each cordless additional device 3, performed on the cordless additional device, is described with reference to a flow chart in FIG. 5.

The processing order shown in FIG. 5 is basically the same as that of FIG. 4. In the processing order of FIG. 5, however, processes corresponding to steps S1 and S2 are not included, and two processes are added. One of them is a process informing a user of the resultant information with respect to the items to be set, i.e. the items ‘notification of paper jam’, ‘notification of low residual ink’, ‘notification of no residual ink’, ‘notification of memory rejection’, ‘notification of machine error’, ‘notification of recording message’, ‘notification of fax receiving completed’, ‘notification of facsimile receiving error’, ‘notification of fax completed’, and ‘notification of fax error’ through the main device 2 when the user selects ‘setting item of operational condition of main device’ from the menu (S31) and the other is a process sending the settings in the cordless additional device 3 to the main device 2 (S54).

Processes corresponding to the steps S1 and S2 are not provided as described above, because the cordless additional device 3 does not need to select a cordless additional device, in other words, the cordless additional device has been already determined as a cordless additional device for displaying the items of the operational condition of the main device 2. Alternatively, in the case of the cordless additional device 3, the steps S1 and S2 may be provided and the items of the operational condition of the main device 2 may be set for another cordless additional device 3.

In the above cordless additional device 3, a process for taking information for setting the item of the operational condition through the main device 2 is provided because the items to be displayed vary as the main device 2 having additional cordless additional devices 3 has various other multiple functions or the cordless additional device may not be added according to the type of main device 2.

As in the main device 2, when the cordless additional device 3 receives information for setting the items of the operational condition from the main device 2, titles ‘notification of paper jam’, ‘notification of low residual ink’, ‘notification of no residualink’, ‘notification of memory rejection’, ‘notification of machine error’, ‘notification of recording message’, ‘notification of fax receiving completed’, ‘notification of facsimile receiving error’ and ‘notification/not notification’ are displayed on the display unit 304 in this order (S32, S34, S36, S40, S42, S44, S46, S48, S50, S52).

In the cordless additional device 3, the left and right keys of the arrow key 306 correspond to the arrow keys 214 of the main device 2 and the menu/set button 308a also corresponds to the menu/set button 213a of the main device 2; therefore, a user determines whether to display the setting about each item on the display unit by repeatedly operating the left and right keys of the arrow key 306 and the menu/set button 308a every time each item is displayed on the display unit 304 (S33, S35, S37, S39, S41, S43, S45, S47, S49, S51, S53).

When a user sets whether to display last item ‘notification of fax error’, after the setting is transmitted to the main device 2 (S54), a message ‘The notification of operational condition is completely set’ is displayed in the display area of the display unit 304 for a preset time (for example, 5 seconds) (S55) and the setting of the items of the operational condition for the cordless additional device 3 is completed. In the main device 2, setting information of the items displaying the operational condition transmitted from the cordless additional device 3 is stored in the RAM of the main control part 13.

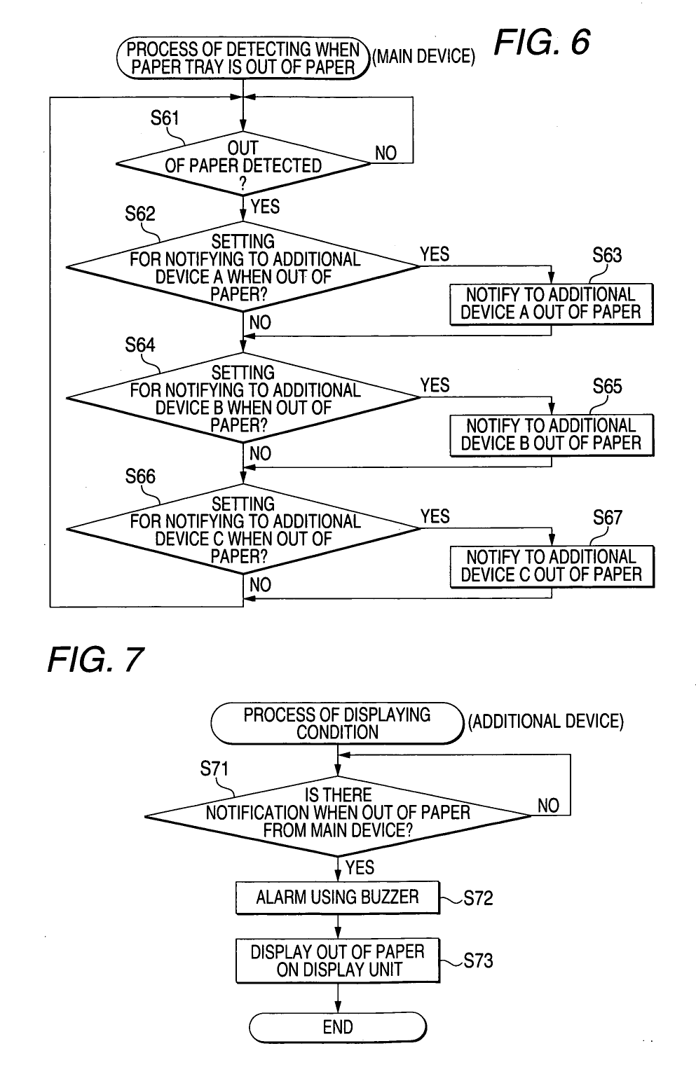

Next, a processing order of the items from (a) out of paper to (k) fax error when the operational condition corresponding to notification of fax error occurs in the main device 2 is described below. For simple explanation, the items ‘notification of out of paper’ and ‘notification of fax completed’ will be described with reference to flow charts in FIGS. 6 to 12, hereafter.

FIG. 6 shows a flow chart illustrating a basic processing order when paper has been used up in the image-reading operation in the main device 2.

In a fax (receiving), copy, print, or photo media capturing mode, when it is detected that paper P stacked in the paper feed tray 205 has been used up during the image forming process (S61), the settings about the item ‘notification of out of paper’ for each cordless additional device 3 stored in the RAM of the main control part 13 are referred to (S62, S64, S66). When any one of the cordless additional devices 3 is set to be notified that paper has been used up (yes in one of S62, S64, S66), the main device 2 informs the cordless additional device 3 the condition.

For example, when only the cordless additional device No. 1 (cordless additional device A) is set to be notified that paper has been used and the others (cordless additional device B and C) are not, the process continues from step 62 (S62) to step 63 (S63) and the cordless additional device A is informed of the notification out of paper.

FIG. 7 shows a flow chart for a receiving process in a cordless additional device when the main device informs the cordless additional device that paper has been used up.

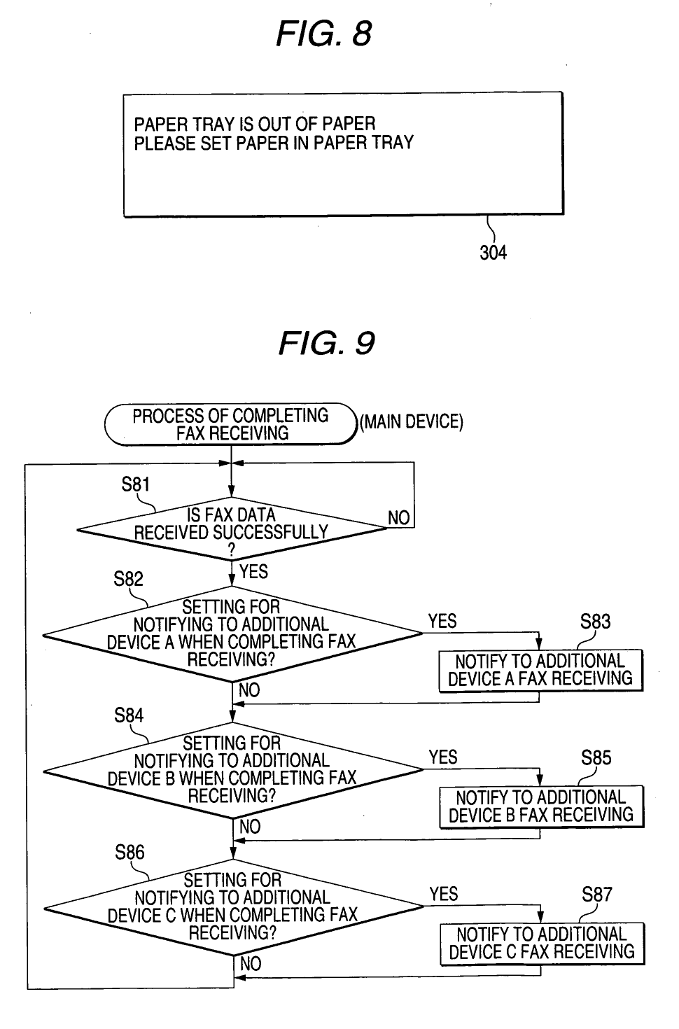

In the main device 2, when paper has been used up, the communication line with the cordless additional device A is secured and data for the condition is transmitted. In the cordless additional device A, when the main device 2 requests the cordless additional device A on standby to secure the communication line, the cordless additional device A receives the data for the out of paper condition from the main device 2(S71). Next, after receiving the information with respect to the operational condition of the main device 2 from the main device 2, the cordless additional device A sounds a predetermined alarm different from the bell of a phone call through the speaker 302 to inform a user of the condition (S72) and displays a message of the operational condition transmitted from the main device 2 on the display unit 304 (S73). As shown in FIG. 8, for example, messages ‘Paper feed tray is out of paper’ and ‘Please set paper in paper feed tray’ are displayed in two lines and predetermined pictograms are displayed at the lowermost line. Alternatively, the messages ‘Paper feed tray is out of paper’ and ‘Please set paper in paper feed tray’ may be spoken instead of the alarm.

For the alarm display, the message may be continually displayed until a user presses a predetermined button to remove the alarm display, or only the characters may be removed except for the pictogram in a preset time. When the out of paper condition is released by replenishing paper in the main device 2, the main device 2 informs the cordless additional device A about the releasing. Therefore, in case the alarm has been continually displayed on the display unit 304 until releasing, the alarm display is removed automatically by the information of releasing.

FIG. 9 shows a flow chart illustrating a basic processing order when the recipient's facsimile apparatus faxes data to the main device 2 on standby in fax mode and the data is received normally.

When the recipient's facsimile apparatus faxes data to the main device 2 on standby in fax mode and the data is received normally (S81), the settings about the item ‘notification of facsimile receiving completed’ for each cordless additional device 3 stored in the RAM of the main control part 13 are checked (S82, S84, S86). When any one of the cordless additional devices 3 is set to be notified of ‘the fax receiving completed’ (yes in one of S82, S84, S86), the main device 2 informs the cordless additional device 3 that the fax receiving has been completed.

For example, when two cordless additional devices No. 1 (cordless additional device A) and No. 2 (cordless additional device B) of the three cordless additional devices are set to be notified that fax receiving has been completed and the other cordless additional device No. 3 (cordless additional device C) is not, the process continues from steps S82 and S84 to steps S83 and S85, respectively, the cordless additional devices A and B are informed that the fax receiving has been completed.

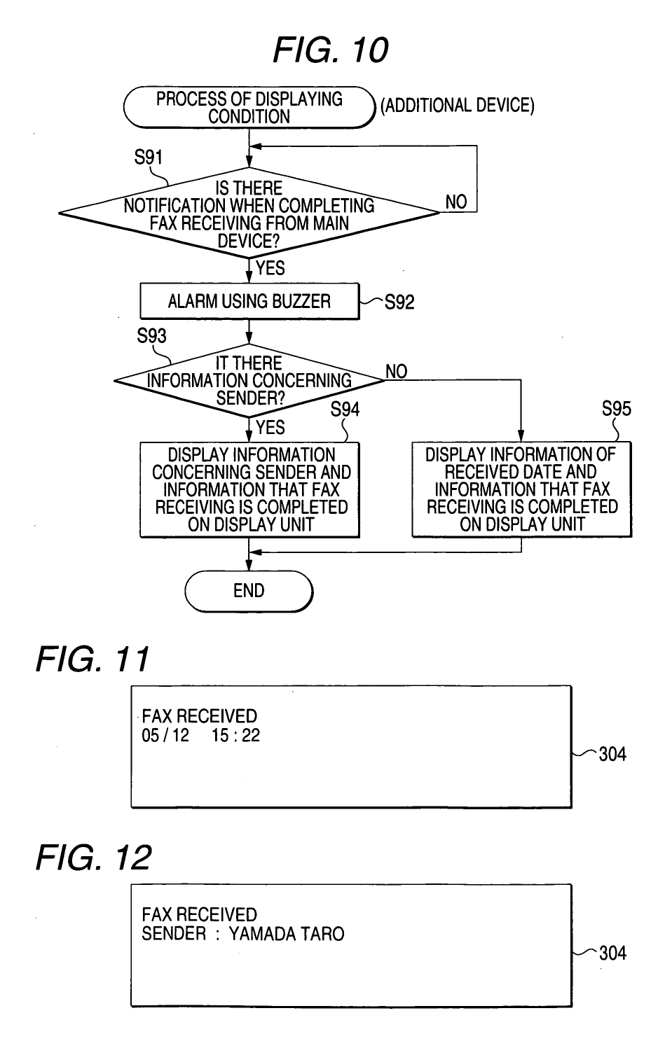

FIG. 10 shows a flow chart illustrating a receiving process in the cordless additional device when the main device informs the cordless additional device that fax receiving has been completed.

When the recipient's facsimile apparatus faxes data to the main device 2 and the data is normally received, the main device secures the communication line and transmits the data for the fax receiving completion. When the main device 2 requests the cordless additional device A on standby to secure the communication line, the hand set A receives the data for the fax receiving completion from the main device according to the request (S91). When the cordless additional device A receives information with respect to the operational condition of the main device 2 from the main device 2, after receiving the information with respect to the operational condition of the main device 2 from the main device 2, the cordless additional device A sounds a predetermined alarm different from the bell of a phone call through the speaker 302 to inform a user of the condition (S92) and displays a message of the operational condition transmitted from the main device 2 on the display unit 304 (S93 to 95).

In this case, when information concerning a sender is not included in the operational condition transmitted from the main device 2 (S93: NO), the reception of a fax data and the receiving time are displayed on the display unit 304 (S95). For example, as shown in FIG. 11, a message ‘FAX received’ (information concerning the reception of a fax data) is displayed in the first line of the display unit 304 and a message ‘05/12 15:22’ (information with respect to the receiving time) is displayed in the second line.

On the other hand, when information concerning a sender is included in the operational condition transmitted from the main device 2 (S93: YES), the reception of fax data and the information concerning the sender are displayed on the display unit 304 (S94). For example, as shown in FIG. 12, a message ‘FAX received’ (information concerning the recipient of a fax data) is displayed in the first line of the display unit 304 and a message ‘sender: Yamada Taro’ (information concerning a sender) is displayed in the second line.

The above messages may be continually displayed until a user removes them by operating a predetermined button or in a preset time. In the notification of ‘fax receiving completed’, a message such as ‘FAX data has been received’ may also be spoken instead of an alarm.

In the above aspect, although the controlling of display in a cordless additional device is described in the case of the notification of ‘out of paper’ and ‘fax receiving completed’, processing orders of displaying the other items basically has the same processing order as that of the above-mentioned cases.

As described above, according to the facsimile apparatus 1 including the cordless additional device according to the aspect, a user may selectively allow each cordless additional device to display desired operational condition of various operational condition such as an error in a main device 2, fax receiving completion, and recording a message; therefore, a user using each cordless additional device 3 may check desired operational condition of the main device 2 in a place distanced from the main device 2.

Items of operational condition to be displayed in a cordless additional device 3 may be set by either a main device 2 and the cordless additional device 3, and thus the items of the operational condition are easily set.

In information with respect to abnormal operation of the main device 2 such as ‘paper jam’, ‘low residual ink, ‘out of ink, ‘memory full, ‘machine error’, when the display unit 201 of the main device 2 specifically displays abnormal or adverse information, the same information also may be displayed specifically or simply on the display unit 304 of the cordless additional device 3. For example, in ‘paper jam’, when the main device 2 displays on the display unit which one or both paper jams A and B, the same information or only the paper jam may be displayed on the display unit 304 of the cordless additional device 3.

Similarly, in ‘machine error’, it is preferable to display which component in the parts, such as the image-reading part 5, image-recording part 6, facsimile communication control part 7, wireless communication control part 9, media-reading part 10, made an error. Even though it is not described in the aspect, it is preferable to detect nozzle clogging at the image-recording part 6 and display it at the cordless additional device. Furthermore, when a mechanism to open up the nozzle clogging is provided, it is preferable to display the opening-up the clogging with the mechanism at the cordless additional device 3.

In the notification of a adverse information such as ‘low residual ink’ or ‘low residual memory’, the amount of residual ink or memory may be displayed in a percentage. In the above aspect, although an inkjet typed image-recording unit is described as the image-recording part 6, an image-recording unit other than the inkjet type, for example, the invention may also employ an electrostatic printing type image-recording unit.

When a large amount of image data is recorded in the data memory part 8 by a answering machine and the process of outputting the data onto paper is on standby, or when a large amount of image data is recorded in the data memory part 8 by memory transmitting function and the process of transmitting the data to the recipient's facsimile apparatus is on standby (residual job condition), this stand by condition may be displayed by the cordless additional device 3.

In the notification of ‘fax receiving completed’, it is possible to determine which additional device is notified, according to senders in a hone number storage, independently from the above-mentioned menu.

In the above aspect, there has been described a facsimile apparatus having print, copy, scan, fax, and photo media capturing functions. However, the main device according to the invention need not have all the functions and may have at least the fax and wireless telephone functions.

As was described according to an aspect of the invention, there is provided a facsimile apparatus including: a main device being capable of performing at least one of telephone communication and facsimile communication with a remote side apparatus connected through a telephone line; an additional device being capable of performing at least one of telephone communication and data communication wirelessly; an item setting part that sets items of operational condition of the main device recognizable through the additional device; an information generating part provided in the main device and generating information of the operational condition of the main device; an information transmitting part that transmits information corresponding to the items set by the item setting part, among the information of the operational condition of the main device generated by the information generating part; and an information output part provided in each additional device and outputting the transmitted information to notify a user when the additional device receives the information of the operational condition of the main device transmitted from the information transmitting part.

Accordingly, the main device transmits information with respect to its operational condition set by an item setting part of each cordless additional device to the cordless additional devices, which output the information for users to recognize it, therefore, each user is able to check desired operational condition of the operational condition of the main device.

Thus, when each cordless additional device is disposed at places other than the place where the main device is disposed, each user is able to easily check desired operational condition of the main device at the distant place.

According to another aspect of the invention, the item setting part includes: a memory part that stores a menu for selection of the items of the operational condition of the main device; a menu display part that displays the menu; and an item selecting part that is operated by a user to select a desired item from the menu displayed by the menu display part.

The display part displays the items of operational condition of the main device, so that a user is able to select desired items through the menu. Therefore, a user is able to easily set desired items.

According to another aspect of the invention, the item setting part is provided in at least one of the main device and the additional device.

A user is able to set items using any one of item setting parts in the main device or the cordless additional device, thus easily sets the items with simple operations.

According to another aspect of the invention, the menu displayed by the menu display part includes a first mode for independently setting the items of the operational condition of the main device to each additional device and a second mode for independently setting the same item of the operational condition of the main device to all of the additional devices, and the first and second modes are selectable by the user using the item selecting part.

A user is able to not only set items of desired operational condition to each cordless additional device through a menu displayed by the display part, but set the same items to all the cordless additional devices at one time. Therefore, when setting items of the same operational condition to several cordless additional devices, a user does not need to repeat the same operations, thus can easily set items.

According to another aspect of the invention, an output process of the information output part includes at least one of a process of displaying the information of the operational condition of the main device transmitted from the information transmitting par ton the display part, using characters or symbols, and a process of outputting a voice corresponding to the information by a speaker.

Because information with respect to the operational condition which has been set is displayed by a display part or spoken, a user is able to surely acknowledge desired operational condition of a main device.

According to another aspect of the invention, the main device includes: an image data acquiring part that acquires image data; a fax transmitting part that transmits the image data to the remote side apparatus through the telephone line; a fax receiving part that receives image data transmitted from the remote side apparatus through the telephone line; an image forming part that forms the image data onto a sheet; a control part that controls the image data acquiring part, fax transmitting part, fax receiving part, and image forming part, the control part including a fax transmitting control part transmitting the image data read by the image data reading part to the remote side apparatus through the telephone line using the fax transmitting part and a fax receiving control part printing the image data received from the remote side apparatus through the telephone line by the fax receiving part onto the sheet using the image forming part; and an error detecting part that detects operating errors in each of the image data reading part, fax transmitting part, fax receiving part, image forming part, and control part, and wherein the item of the operational condition recognizable through the additional device includes at least the operating errors in each part detected by the error detecting part, and transmitting and receiving results in the fax transmitting part and the fax receiving part.

According to still another aspect of the invention, the image data acquiring part includes at least a document reading part that reads a document and outputs it as an image data and an image data receiving part that receives image data transmitted from an external image data creating part, and the control part controlling the image data acquiring part, fax transmitting part, fax receiving part, and image forming part, further includes a printing control part that prints the image data output from the document reading part or the image data received by the image data receiving part using the image forming part and a second fax transmitting control part that transmits the image data received by the image data receiving part to the remote side apparatus through the telephone line using the fax transmitting part.

Thus, a user is able to check information with respect to the operational condition or a main device including at least operating errors in a image data acquiring part, fax transmitting part, fax receiving part, image forming part, and control par, and transmitting and receiving result in the fax transmitting part and the fax receiving part. Therefore, the user can also easily check the information with respect to the operational condition of the main device at places distant from the main device.

According to another aspect of the invention, the facsimile apparatus further includes an image data memory part that stores voice data transmitted from the remote side apparatus, the image data acquired by the image data acquiring part, and the image data received by the fax receiving part; a first determining part that determines whether a residual capacity of the data memory part is less than a predetermined value; and a second determining part that determines whether the voice data is stored in the data memory part by an answering machine, and wherein the recognizable item further includes the determined result by the first and second determining parts.

A user is able to check messages recorded by an answering machine and whether a residual capacity of a data memory part storing the messages data and fax receiving data for a time drops below a predetermined value, through a cordless additional device. Accordingly, the user is able to easily check the messages or whether the answering machine has received any message and whether the facsimile apparatus has received any document.

What is claimed is:

1. A facsimile apparatus comprising:
a main device being capable of performing at least one of telephone communication and facsimile communication with a remote side apparatus connected through a telephone line;
an additional device being capable of performing at least one of telephone communication and data communication wirelessly;
an item setting part that sets items of operational condition of the main device recognizable through the additional device;
an information generating part provided in the main device and generating information of the operational condition of the main device;
an information transmitting part that transmits information corresponding to the items set by the item setting part, among the information of the operational condition of the main device generated by the information generating part; and
an information output part provided in each additional device and outputting the transmitted information to notify a user when the additional device receives the information of the operational condition of the main device transmitted from the information transmitting part.

2. The facsimile apparatus according to claim 1, wherein the item setting part comprises:
a memory part that stores a menu for selection of the items of the operational condition of the main device;
a menu display part that displays the menu; and
an item selecting part that is operated by a user to select a desired item from the menu displayed by the menu display part.

3. The facsimile apparatus according to claim 2, wherein the item setting part is provided in at least one of the main device and the additional device.

4. The facsimile apparatus according to claim 2, wherein the menu displayed by the menu display part includes a first mode for independently setting the items of the operational condition of the main device to each additional device and a second mode for independently setting the same item of the operational condition of the main device to all of the additional devices, and the first and second modes are selectable by the user using the item selecting part.

5. The facsimile apparatus according to claim 1, wherein an output process of the information output part includes at least one of a process of displaying the information of the operational condition of the main device transmitted from the information transmitting part on the display part, using characters or symbols, and a process of outputting a voice corresponding to the information by a speaker.

6. The facsimile apparatus according to claim 1, wherein the main device comprises:
an image data acquiring part that acquires image data;
a fax transmitting part that transmits the image data to the remote side apparatus through the telephone line;
a fax receiving part that receives image data transmitted from the remote side apparatus through the telephone line;
an image forming part that forms the image data onto a sheet;
a control part that controls the image data acquiring part, fax transmitting part, fax receiving part, and image forming part, the control part including a fax transmitting control part transmitting the image data read by the image data reading part to the remote side apparatus through the telephone line using the fax transmitting part and a fax receiving control part printing the image data received from the remote side apparatus through the telephone line by the fax receiving part onto the sheet using the image forming part; and
an error detecting part that detects operating errors in each of the image data reading part, fax transmitting part, fax receiving part, image forming part, and control part, and
wherein the item of the operational condition recognizable through the additional device includes at least the operating errors in each part detected by the error detecting part, and transmitting and receiving results in the fax transmitting part and the fax receiving part.

7. The facsimile apparatus according to claim 6, wherein the image data acquiring part includes at least a document reading part that reads a document and outputs it as an image data and an image data receiving part that receives image data transmitted from an external image data creating part, and
the control part controlling the image data acquiring part, fax transmitting part, fax receiving part, and image forming part, further includes a printing control part that prints the image data output from the document reading part or the image data received by the image data receiving part using the image forming part and a second fax transmitting control part that transmits the image data received by the image data receiving part to the remote side apparatus through the telephone line using the fax transmitting part.

8. The facsimile apparatus according to claim 6, further comprising:
an image data memory part that stores voice data transmitted from the remote side apparatus, the image data acquired by the image data acquiring part, and the image data received by the fax receiving part;
a first determining part that determines whether a residual capacity of the data memory part is less than a predetermined value; and
a second determining part that determines whether the voice data is stored in the data memory part by an answering machine, and
wherein the recognizable item further includes the determined result by the first and second determining parts.
